(19) United States
(12) Patent Application Publication
(10) Pub. No.: US 2009/0120557 A1
(43) Pub. Date: May 14, 2009

(54) SYSTEM FOR REINFORCING AND MONITORING SUPPORT MEMBERS OF A STRUCTURE AND METHODS THEREFOR

(76) Inventors: JERRY M. SERRA, Chelmsford, MA (US); Adalbert E. Lavature, Huntington, MA (US)

Correspondence Address: MALDJIAN & FALLON LLC, 365 BROAD ST. , 3RD FLOOR, RED BANK, NJ, 07701, US

(21) Appl. No.: 12/264,574

(22) Filed: Nov. 4, 2008

Related U.S. Application Data
(60) Provisional application No. 60/987,142, filed on Nov. 12, 2007.

(51) Int. Cl. B32B 38/10; B32B 7/12; B32B 33/00

(52) U.S. Cl. 156/71; 428/354; 428/41.8

(57) ABSTRACT

Embodiments of the present invention are generally related to systems and methods for reinforcing and monitoring the integrity of structural support members, such as concrete support columns for building and bridge support. In one embodiment of the present invention, a flexible reinforcing laminate for structural support members comprises a flexible film, a fibrous layer laminated to the flexible film, an adhesive layer covering the fibrous layer, and at least one sensor integrally formed within the flexible reinforcing laminate

### CROSS-REFERENCE TO RELATED APPLICATIONS

This application claims priority to U.S. Provisional Patent Application Ser. No. 60/987,142, filed Nov. 12, 2007, entitled “A System for Reinforcing and Monitoring Support Members of a Structure and Methods Therefor,” the disclosure of which is incorporated herein by reference in its entirety.

### BACKGROUND OF THE INVENTION

1. Field of the Invention

Embodiments of the present invention are generally related to systems and methods for reinforcing structures. More particularly embodiments of the present invention are related to systems and methods for reinforcing and monitoring the integrity of structural support members, such as concrete support columns.

2. Description of the Related Art

Structures, such as buildings, parking garages and bridges, may be damaged, collapse, or become unsafe when the structural support members therein are weakened by catastrophic events such as earthquakes, tornados and hurricanes. Structural support members may also be weakened by wear and tear, fatigue exposure to the elements, or dry rot.

There are serious consequences associated with weakened or failing structural support members. In many instances, the failure of a structural support member results in an injury, the loss of life, or costly damage to a structure. Many damaged structures cannot be repaired and must be torn down.

In view of the above, there have been many efforts directed to reinforcing structural support members. For example, concrete bridge columns have been frequently retrofitted with steel jackets by placing the steel jackets around the columns. There are a number of drawbacks associated with this technique. In particular, the steel jackets must be custom made to fit the various diameters of the support columns, the steel jackets must be welded in place using highly skilled labor, installation of the steel jackets requires heavy equipment, and a weak bond is often formed between the steel jackets and the support columns.

FIGS. 1-3 show a prior art method of reinforcing a support member of a structure. Referring to FIG. 1, the structure 50 includes a first level 52, a second level 54 and concrete support columns 56A, 56B that support the second level above the first level. Referring to FIG. 2, in order to reinforce the structural integrity of the concrete support columns 56A, 56B and the structure 50, a roll 58 of a reinforcing mesh fabric 60 is secured around the concrete support columns 56A, 56B. Before being applied to the support columns 56A, 56B, the reinforcing mesh fabric 60 is first dipped in a curable resin 62. Referring to FIG. 3, the resin-impregnated mesh fabric 60 is then wrapped around the concrete support columns 56A, 56B. The resin is then cured to hold the mesh fabric 60 on the support columns. In the particular structure shown in FIG. 3, three distinct sections 60A-1, 60A-2 and 60A-3 of the mesh fabric are wrapped around the first support column 56A, and another three distinct sections 60B-1, 60B-2 and 60B-3 of the mesh fabric are wrapped around the second support column 56B.

As described hereinabove, the conventional practice in the industry involves using a two-part liquid system such as an epoxy based resin. This system requires a cure time, the mixing of chemicals at the job site, and limited application temperature ranges. If any of these steps are performed incorrectly, then the final product will likely be defective. Thus, in conventional systems, too many quality control variables remain in the hands of the installers.

Thus, there remains a need for improved systems and methods for reinforcing and monitoring the integrity of structural support members of structures such as buildings and bridges.

### SUMMARY OF THE INVENTION

Embodiments of the present invention are generally related to systems and methods for reinforcing and monitoring the integrity of structural support members, such as concrete support columns for building and bridge support. In one embodiment of the present invention, a flexible reinforcing laminate for structural support members comprises a flexible film, a fibrous layer laminated to the flexible film, an adhesive layer covering the fibrous layer, and at least one sensor integrally formed within the flexible reinforcing laminate.

In another embodiment of the present invention, a system for reinforcing a structural support member comprises a structural support member for supporting at least a portion of a weight of a structure, and a flexible reinforcing laminate covering a portion of an outer surface of the structural support member, the laminate comprising a flexible film, a fibrous layer laminated to the flexible film, an adhesive layer covering the fibrous layer and adhering the laminate to the portion of the outer surface of the structural support member, and at least one sensor integrally formed within the flexible reinforcing laminate.

In yet another embodiment, a method of reinforcing a structure having structural support members comprises providing a flexible reinforcing laminate for structural support members comprising a flexible film, a fibrous layer laminated to the flexible film, an adhesive layer covering the fibrous layer, at least one sensor integrally formed within the flexible reinforcing laminate, and a release liner covering the adhesive layer, removing the release liner for uncovering the adhesive layer, and wrapping the flexible reinforcing laminate around at least a portion of an outer surface of one of the structural support members.

These and other embodiments of the present invention will be described in more detail below.

### BRIEF DESCRIPTION OF THE DRAWINGS

So the manner in which the above-recited features of the present invention can be understood in detail, a more particular description of the present invention may be had by reference to embodiments, which are illustrated in the appended drawings. It is to be noted, however, that the appended drawings illustrate only typical embodiments encompassed within the scope of the present invention, and, therefore, are not to be considered limiting, for the present invention may admit to other equally effective embodiments, wherein:

FIG. 1 depicts a side elevation view of a structure having support columns;

FIG. 2 depicts a prior art method of reinforcing the support columns shown in FIG. 1 by using a reinforcing wrap;

FIG. 3 depicts the support columns shown in FIG. 1 after being reinforced by the reinforcing wrap shown in FIG. 2;

FIGS. 4A-4D depict a method of reinforcing a support member of a structure using a flexible reinforcing laminate, in accordance with certain embodiments of the present invention;

FIGS. 5A-5B depict a method of reinforcing structural support members using the flexible reinforcing laminate depicted in FIGS. 4A-4B;

FIG. 6 depicts a system for reinforcing and monitoring the structural integrity of structural support members, in accordance with certain embodiments of the present invention;

FIGS. 7A-7D depict a method of reinforcing a support member of a structure using a flexible reinforcing laminate, in accordance with another embodiment of the present invention;

FIG. 8 depicts a support structure reinforced by a flexible reinforcing laminate, in accordance with a further embodiment of the present invention; and

FIGS. 9-11 depict top plan views of flexible reinforcing laminates having one or more sensors integrated therein, in accordance with still further embodiments of the present invention.

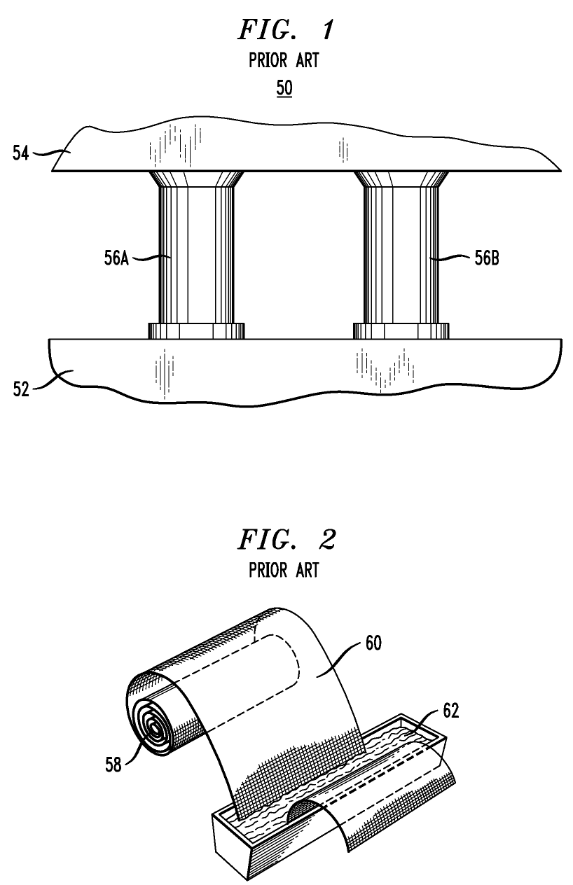

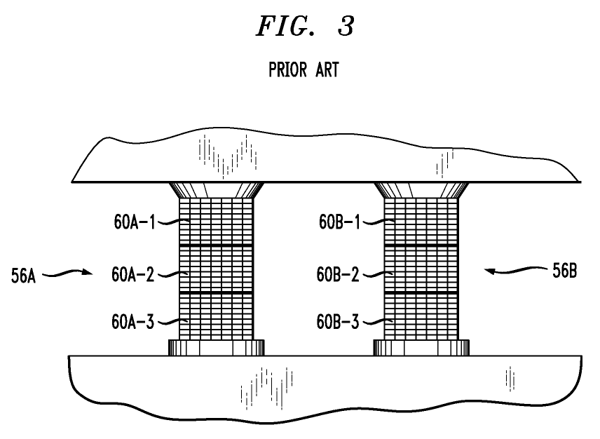

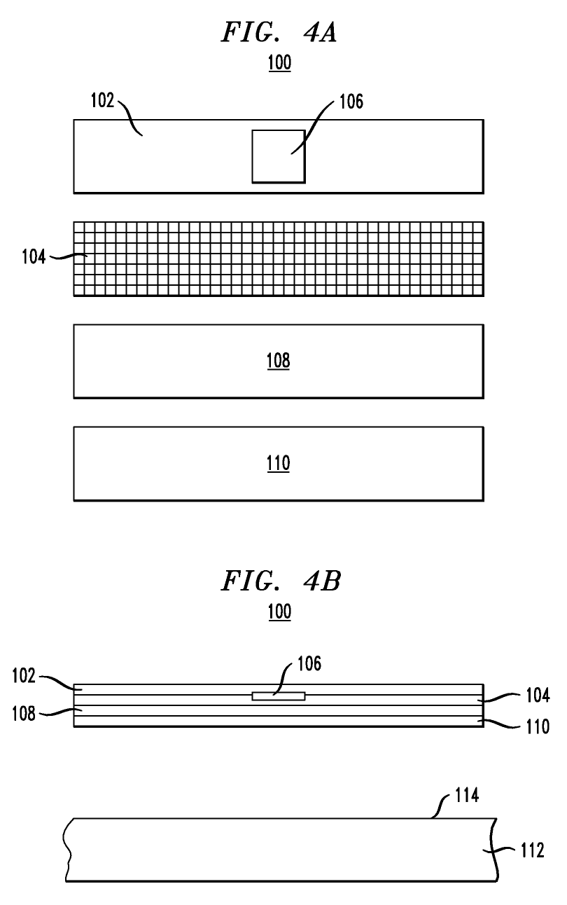

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

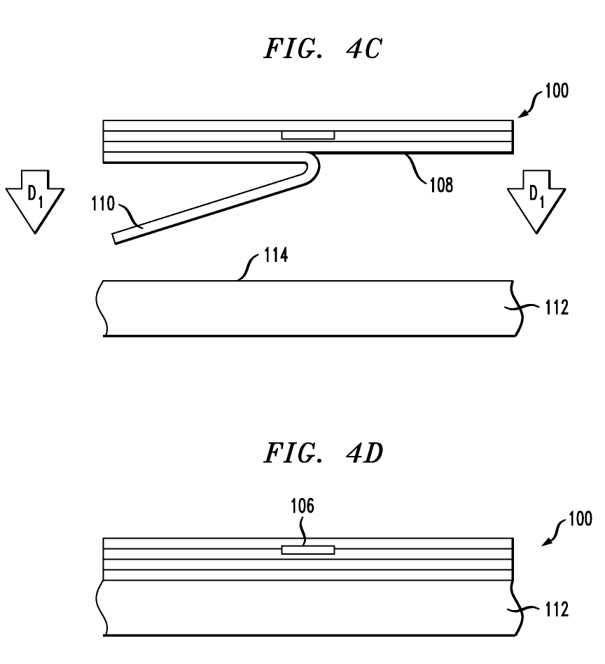

Referring to FIGS. 4A and 4B, in accordance with one embodiment of the present invention, a flexible reinforcing laminate 100 comprises a first layer 102, such as a polymeric film, a mesh or fibrous layer 104 attached to the first layer 102 and an adhesive layer 108. The flexible reinforcing laminate 100 may also include an optional sensor 106, such as a seismic sensor, a piezoelectric sensor, a temperature sensor or a moisture sensor.

The adhesive layer 108 may include a pressure sensitive adhesive or a resinous material. In many embodiments, the adhesive layer 108 comprises at least one of acrylic-based, polyurethane-based, rubber-based or silicone-based pressure sensitive adhesive. In other embodiments, the adhesive layer 108 comprises natural or synthetic rubbers or blends thereof. In one embodiment, the adhesive layer 108 further comprises at least one of a tackifier, a stabilizer, a colorant, a cross-linker or the like.

In accordance with embodiments of the present invention, the first layer 102 comprises a polymeric film. The polymeric film may comprise polyurethane, a polyolefin, including a thermoplastic polyolefin, or the like.

The fibrous layer 104 generally comprises a woven fibrous material having a predetermined thread density (i.e., number of threads in a given length). The fibrous layer 104 may comprise organic fibers, synthetic fibers, inorganic fibers or combinations thereof. The fibrous layer may also comprise natural or synthetic fibers, such as fiberglass, carbon fibers, metal fibers or blends thereof.

In one embodiment the fibrous layer 104 comprises a plurality of woven fibers having a thread density of between about 1 thread per inch and about 250 threads per inch.

Alternative embodiments of the present invention provide a fibrous layer 104 having a coating or a plurality of coatings surrounding the woven fibrous material. For example, in one embodiment, the fibrous layer 104 comprises a plurality of woven fibers encapsulated in an adhesive resin or a pressure sensitive adhesive composition.

In another embodiment, the flexible reinforcing material sheet 100 also includes an optional protective layer or release liner 110 that covers the adhesive layer 108. The release liner 110 is removable from the adhesive layer 108 so the flexible reinforcing material sheet 100 may be adhered to a support member of a structure. The release liner 110 may also assist in maintaining the adhesive layer 108 in a partially cured state, whereby the adhesive layer would not fully cure until the release liner 110 has been removed.

Referring to FIG. 4B, in accordance with an embodiment of the present invention, the optional sensor 106 is embedded within the flexible reinforcing material sheet 100. As shown in the Figure, the sensor 106 is positioned in a central region of the sheet 100. However, the sensor 106 may be positioned at any location on the sheet. In one particular embodiment, the sensor may be positioned at a lower edge of the sheet 100 such as when the sheet is used for monitoring moisture infiltration. In another embodiment, the sensor may be positioned at an upper edge of the sheet such as when the sheet is used for monitoring the temperature around a support member.

Referring to FIG. 4B, the flexible reinforcing material sheet 100 may be adhered to a support member 112, such as a concrete support column, having an outer surface 114. The sheet 100 is present at the site of the support member 112 with the release liner covering the adhesive layer 108. Referring to FIG. 4C, the release liner is removed to expose the adhesive layer 108, and the adhesive layer 108 is juxtaposed with the outer surface 114 of the support member 112. The sheet 100 is then moved in the direction designated D1.

FIG. 4D depicts the flexible reinforcing material sheet 100 after it has been attached to the support member 112. The sheet 100 reinforces the support member 112 for enhancing the structural integrity of the support member. The sensor 106 embedded in the sheet 100 enables the structural integrity of the support member 112 to be substantially continuously monitored and/or one or more environmental conditions (e.g., temperature, humidity, moisture) at the support member to be monitored. The sensor 106 is preferably in communication with a monitor or control system capable of receiving signals from the sensor to collect feedback data from the sensor.

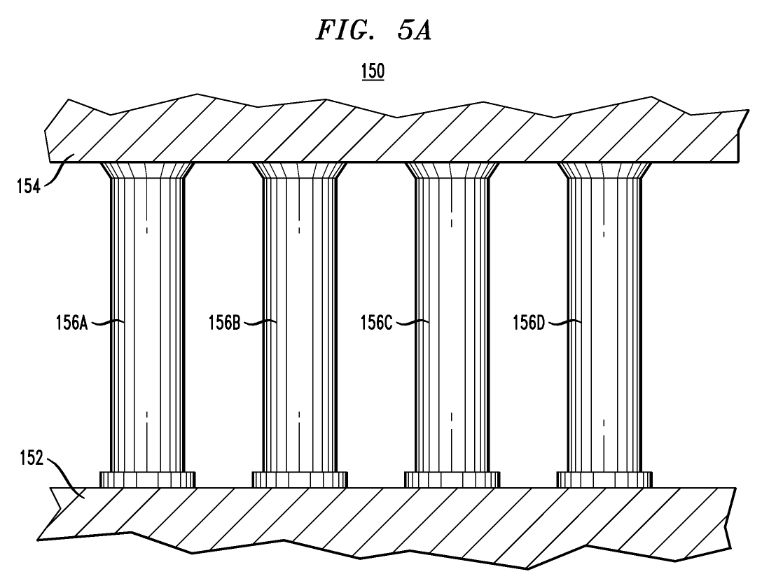

FIG. 5A shows a structure 150 including a first level 152, a second level 154 and support members 156A-156D that support the second level 154 above the first level 152. The structure 150 may be a building or a bridge and the support members 156A-156D may be any load bearing elements (e.g., concrete support columns) normally found in a structure.

Referring to FIG. 5B, a flexible reinforcing laminate 100, in accordance with embodiments of the present invention, is adhered to the support members 156A-156D. As shown in FIG. 5B, a first sheet 100A is adhered to first support member 156A, a second sheet 100B is adhered to second support member 156B, a third sheet 100C is adhered to third support member 156C, and a fourth sheet 100D is adhered to fourth support member 156D. In the embodiment shown in the Figure, each of the flexible reinforcing material sheets 100A-100D has at least one sensor 106 embedded therein. Each of the sensors 106A-106D preferably has a unique identifier code used to identify each of the support members 156A-156D. For example, the first sensor 106A has an identifier code that links the sensor with the first support column 156A. The first sensor 106A may sense various conditions such as the structural integrity of the first support member 156A, the temperature at the first support member 156A, the presence of water or moisture at the first support member 156A, etc. The information sensed by the sensors 106A-106D may be transmitted via land-line, wirelessly, the internet, etc.

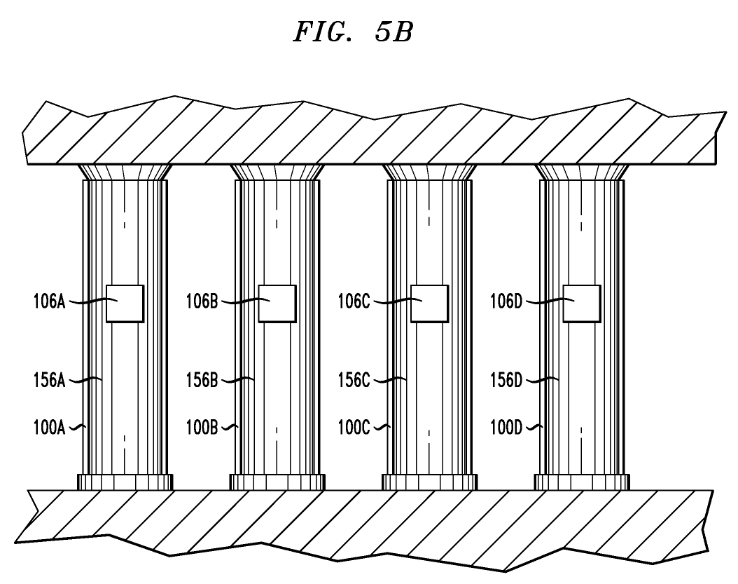

FIG. 6 shows a system for reinforcing and monitoring support members of a structure, in accordance with certain embodiments of the present invention. The system 160 includes support members 156A-156D and sheets of a flexible reinforcing material 100A-100D adhered to the support members, respectively. Each of the reinforcing sheets 100A-100D has at least one sensor 106A-106D integrally formed therewith. The sensors 106A-106D are in communication with a monitor 162 that collects the sensor readings obtained by the respective sensors.

The monitor 162 may include a microprocessor 164 having a program for controlling operation of the sensors and the overall operation of the system. In the embodiment shown in FIG. 6, the sensors are adapted to wirelessly transmit the sensed information from the sensors to the monitor. In turn, the monitor may be in communication with a control center 166 via a satellite uplink/downlink 168, telephone line, wireless communication line, the internet, etc. The control center 166 may be in communication with hundreds or thousands of structures in a configuration similar to that shown in FIG. 6. As a result, the control center may continuously monitor the structural integrity and/or environmental conditions of many different structures.

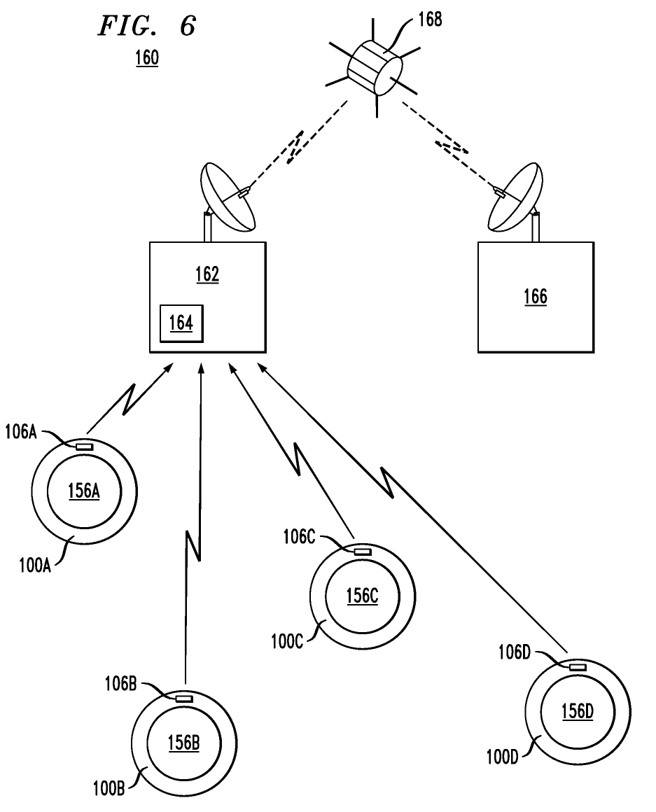

Referring to FIGS. 7A-7B, in accordance with another embodiment of the present invention, a flexible reinforcing laminate 200 includes a first layer 202, such as a polymeric film, a mesh or fibrous layer 204 attached to the first layer 202, and a second layer 205 overlying the fibrous layer 204. The flexible reinforcing laminate 200 may also include a sensor 206, similar to the sensors described above, and an adhesive layer 208, such as a pressure sensitive adhesive or a resinous material, in contact with the second layer 205. The flexible reinforcing material sheet 200 also includes a protective layer or release liner 210 that covers the adhesive layer 208. The release liner 110 is removed from the adhesive layer 108 prior to adhering or attaching the sheet 200 to a support member.

Referring to FIGS. 7C and 7D, in accordance with embodiments of the present invention, the sheet 200 is juxtaposed with a support member 212 having an outer surface 214. The release liner 210 is peeled away to expose the adhesive layer 208 on the sheet 200 and the sheet is attached to the outer surface 214 of the support member 212. The sheet 200 includes the fibrous layer 204 for reinforcing the structural integrity of the support member 212. The sheet 200 optionally includes at least one sensor 206 that senses the conditions at the support member and transmits the sensed data to a monitor or control system.

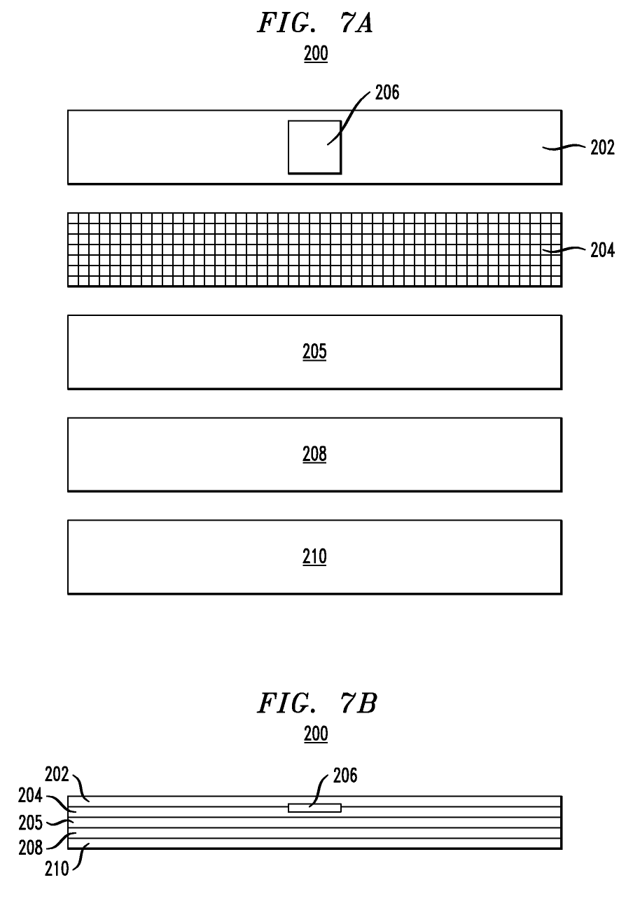

Referring to FIG. 8, in accordance with another embodiment of the present invention, a structure includes a support member 356 having a sheet of a reinforcing material 300 secured thereto. The reinforcing sheet 300 has a water-detection sensor 306 integrated therein. The sensor 306 is pre-positioned in the sheet 300 so it lies adjacent a lower edge of the sheet. As a result, the sensor 306 is able to detect the presence of moisture and/or water at the lower end of the support member 356. The sensor sends signals to a monitor to indicate whether water/moisture is present. In one embodiment, the signals are sent to a monitor in a substantially continuous manner. The sheet 300 also serves to reinforce the support member 356 as described above.

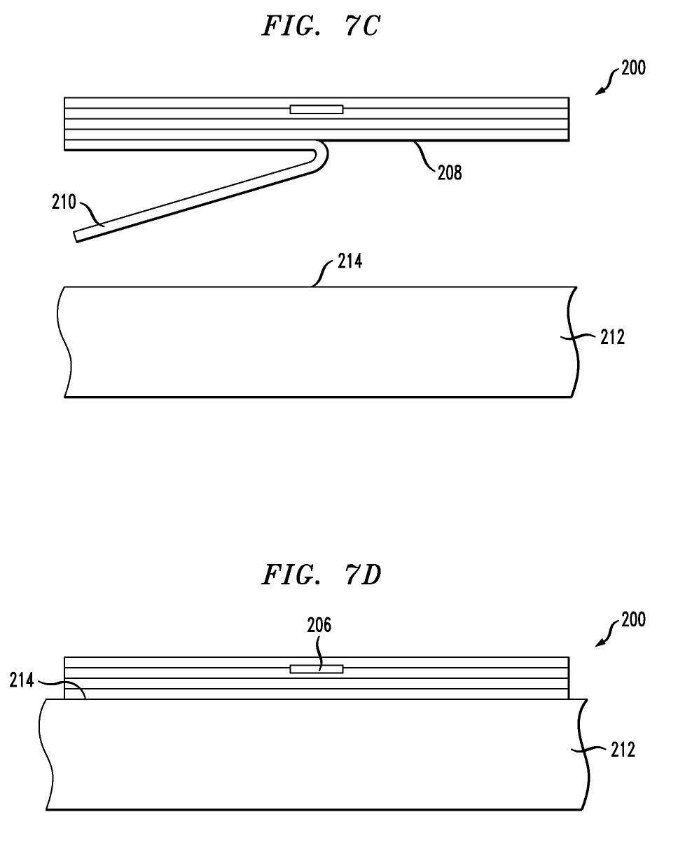

Referring to FIG. 9, in accordance with another embodiment of the present invention, a flexible reinforcing laminate 400 has a single sensor integrally formed therewith. The sensor 406 may be integrally formed with the sheet 400 when the sheet is initially assembled, and prior to bringing the sheet to a worksite. The pre-assembly of the sensor 406 with the sheet 400 insures the sensor is placed at an appropriate location and enhances quality control efforts.

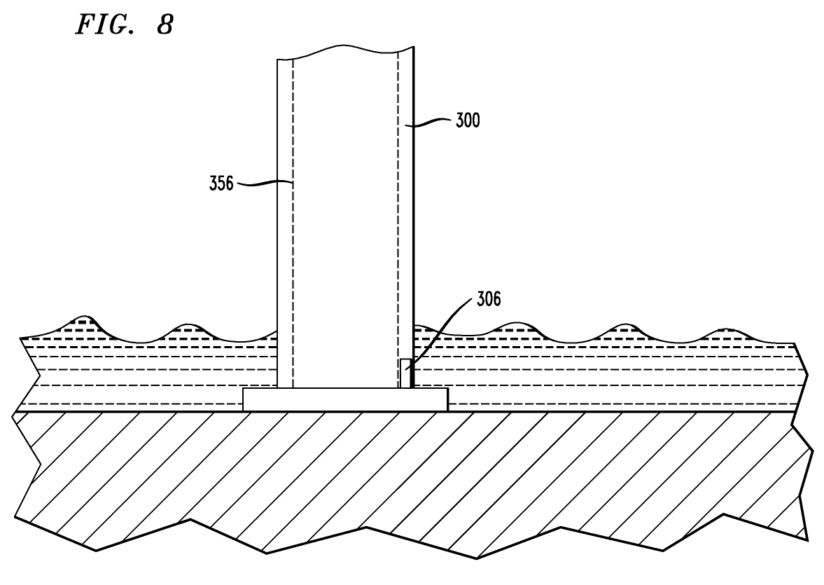

FIG. 10 shows another embodiment wherein two sensors 506A, 506B are integrally formed with a flexible reinforcing laminate. The two sensors 506A, 506B may perform a similar function or a different function. In one embodiment, the first sensor 506A may be a seismic sensor and the second sensor 506B may be a temperature sensor. The sensors 506A, 506B may both perform the same function or may be any combination of the sensors described herein.

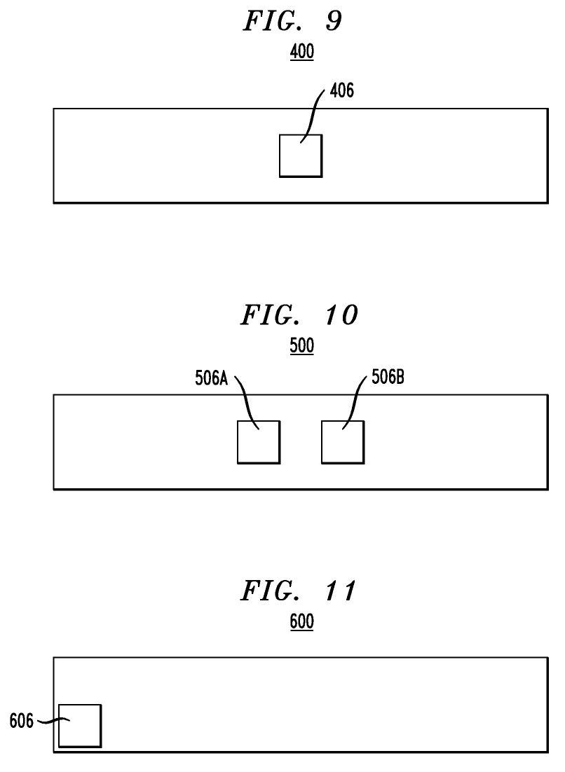

FIG. 11 shows a flexible reinforcing laminate 600 having a sensor 606 positioned at an edge of the sheet in accordance with one embodiment of the present invention. The exact location of the sensor relative to the sheet is determined in part by the function of the sensor. For example, if the sensor 606 is a seismic sensor, it may be placed in a center of the sheet. However, if the sensor is a temperature sensor it may be placed toward an upper end or an edge of a sheet.

While the foregoing is directed to embodiments of the present invention, other and further embodiments of the invention may be devised without departing from the basic scope thereof. Specifically, embodiments of the present invention are further scalable to allow for additional clients and servers, as particular applications may require.

What is claimed is:

1. A flexible reinforcing laminate for structural support members comprising:
a flexible film;
a fibrous layer laminated to the flexible film;
an adhesive layer covering the fibrous layer; and
at least one sensor integrally formed within the flexible reinforcing laminate.

2. The laminate as claimed in claim 1, further comprising a release liner covering the adhesive layer, wherein the release liner is peelable from said adhesive layer for exposing said adhesive layer.

3. The laminate of claim 1, wherein said at least one sensor includes a transmitter for transmitting sensed information.

4. The laminate of claim 1, wherein said at least one sensor comprises a sensor selected from the group of sensors consisting of a seismic sensor, a moisture sensor, a temperature sensor, a movement sensor, an acoustic sensor, and a piezoelectric sensor.

5. The laminate of claim 1, wherein said fibrous layer comprises fibers selected from the group consisting of organic fibers, synthetic fibers, inorganic fibers and combinations thereof.

6. The laminate of claim 1, further comprising a second flexible film disposed between said fibrous layer and said adhesive layer.

7. The laminate of claim 1, wherein the adhesive comprises at least one of a pressure sensitive adhesive, a resinous material, or a B-stage cured adhesive.

8. The laminate of claim 1, wherein said flexible film comprises a polymeric film.

9. The laminate of claim 1, wherein the at least one sensor comprises two or more sensors integrally formed with said flexible reinforcing laminate, wherein a first one of the sensors performs a first function, and a second one of the sensors performs a second function.

10. A system for reinforcing a structural support member comprising:
a structural support member for supporting at least a portion of a weight of a structure; and
a flexible reinforcing laminate covering a portion of an outer surface of the structural support member, the laminate comprising:
a flexible film;
a fibrous layer laminated to the flexible film;
an adhesive layer covering the fibrous layer and adhering the laminate to the portion of the outer surface of the structural support member; and
at least one sensor integrally formed within the flexible reinforcing laminate.

11. The system of claim 10, wherein said at least one sensor comprises a sensor selected from the group of sensors consisting of a seismic sensor, a moisture sensor, a temperature sensor, a movement sensor, an acoustic sensor, and a piezoelectric sensor.

12. The system of claim 10, wherein said at least one sensor includes a transmitter for transmitting sensed information.

13. The system of claim 12, further comprising a monitor in communication with said at least one sensor for receiving information from said at least one sensor.

14. The system of claim 10, wherein the flexible reinforcing laminate is wrapped around the portion of the outer surface of the structural support member.

15. The system of claim 10, wherein the adhesive comprises at least one of a pressure sensitive adhesive, a resinous material, or a B-stage cured adhesive.

16. A method of reinforcing a structure having structural support members comprising:
providing a flexible reinforcing laminate for structural support members comprising:
a flexible film;
a fibrous layer laminated to the flexible film;
an adhesive layer covering the fibrous layer;
at least one sensor integrally formed within the flexible reinforcing laminate; and
a release liner covering the adhesive layer;
removing the release liner for uncovering the adhesive layer; and
wrapping the flexible reinforcing laminate around at least a portion of an outer surface of one of the structural support members.

17. The method of claim 16, wherein the adhesive comprises at least one of a pressure sensitive adhesive, a resinous material, or a B-stage cured adhesive.

18. The method of claim 16, wherein said at least one sensor is selected from the group consisting of a seismic sensor, a temperature sensor, a moisture sensor, a humidity sensor, a piezoelectric sensor, and a movement sensor.

19. The method as claimed in claim 16, further comprising:
transmitting information from the at least one sensor to a monitor adapted to compile information from said at least one sensor.

20. The method of claim 19, further comprising:
coupling a controller with the monitor for processing information received from said monitor.
